(19) United States
(12) Patent Application Publication
(10) Pub. No.: US 2003/0227779 A1
(43) Pub. Date: Dec. 11, 2003

(54) Exterior mirror

(76) Inventors: Ian Boddy, Ada, MI (US); Keith D Foote, Kentwood, MI (US)

Correspondence Address: Robin W Asher, Clark Hill, 500 Woodward Avenue Suite 3500, Detroit, MI, 48226-3435, US

(21) Appl. No.: 10/296,745

(22) PCT Filed: May 29, 2001
(86) PCT No.: PCT/US01/17295

(51) Int. Cl. B60Q 1/00

(52) U.S. Cl. 362/494

(57) ABSTRACT

An exterior rearview mirror assembly for use on an automotive vehicle comprises a support base for mounting the mirror assembly to the vehicle and a mirror housing pivotally connected to the support base by a pivot mechanism for movement between an extended use position and a folded position. A glass mirror pane is connected to the mirror housing and pivotal between a plurality of articulated position for providing a reflective view from the vehicle. A light source is supported by the support base for illuminating an array of light from the mirror assembly. An actuator is connected to the light source and a controller is coupled to the actuator for illuminating and controlling the light source to project the array of light in a selective one of a plurality of discrete directions from the mirror assembly.

### BACKGROUND OF THE INVENTION

1. Field of the Invention

The present invention relates generally to an exterior rearview mirror for use on an automotive vehicle, and more particularly, to an exterior rearview mirror having an assist light operable between a plurality of illuminated positions in response to feedback from a vehicle controller.

2. Description of the Prior Art

Automotive vehicles commonly include exterior rearview mirror assemblies for providing the driver of the vehicle view along the side and toward the rear of the vehicle. The exterior rearview mirror assemblies are typically mounted adjacent the driver's side door and passenger's side door of the vehicle. Conventional exterior rearview mirror assemblies commonly include a support base having a first end for fixedly securing the mirror assembly to the side of the vehicle and a second end for supporting a mirror housing. The mirror housing typically includes a hollow shell for supporting an articulating mirror pane. The mirror pane is adjustable to articulate about an axis for providing varying angles of view to the driver of the vehicle along the side and toward the rear of the vehicle.

It is also known to mount a light source in the mirror assembly for illuminating light adjacent the exterior of the vehicle. These light sources are frequently used to illuminate the rear of the vehicle so that the driver can see at night when looking into the mirror pane during parking of the vehicle. These light sources are also commonly used to provide signal lights within the mirror assembly, such as turn signal lights or brake lights. Still further, these light sources are also used to project a pattern of light on an area, such as the ground, adjacent the side of the vehicle to provide a lighted security zone to assist in entry and exit from the vehicle. Such light sources in rearview mirror assemblies are shown in U.S. Pat. Nos. 5,624,176 and 6,172,602 to Donnelly Corporation.

However, it is desirable to provide an exterior rearview mirror assembly having an assist light that is operable between a plurality of illuminated positions in response to feedback from a vehicle controller to project light from the mirror assembly in a several different selective directions.

### SUMMARY OF THE INVENTION

The present invention relates to an exterior rearview mirror assembly for use on an automotive vehicle. The mirror assembly includes a support base having a first end adapted to mount the mirror assembly to the vehicle and an opposite second end. A mirror housing is operatively coupled to the support base. A reflective mirror pane is supported by the mirror housing for providing a reflected view from the vehicle. The mirror assembly further includes at least one light source mounted to one of the support base or the mirror housing for illuminating at least one array of light. An actuator is operatively connected to the light source for actuating and illuminating the light source to project the array of light in one of a plurality of discrete directions. The mirror assembly also includes a controller for controlling the actuator and illuminating the light source to project the array of light in a selective one of the plurality of discrete directions.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a front perspective view of an exterior rearview mirror assembly in an extended position according to the subject invention;

FIG. 2 is a rear perspective view of the mirror assembly in a folded position;

FIG. 3 is a partially exploded and partially broken perspective view of a light source mounted to the mirror assembly according to the subject invention; and

FIG. 4 is a logic control table of the operation of the mirror assembly.

### DETAILED DESCRIPTION OF THE PREFERRED EMBODIMENT

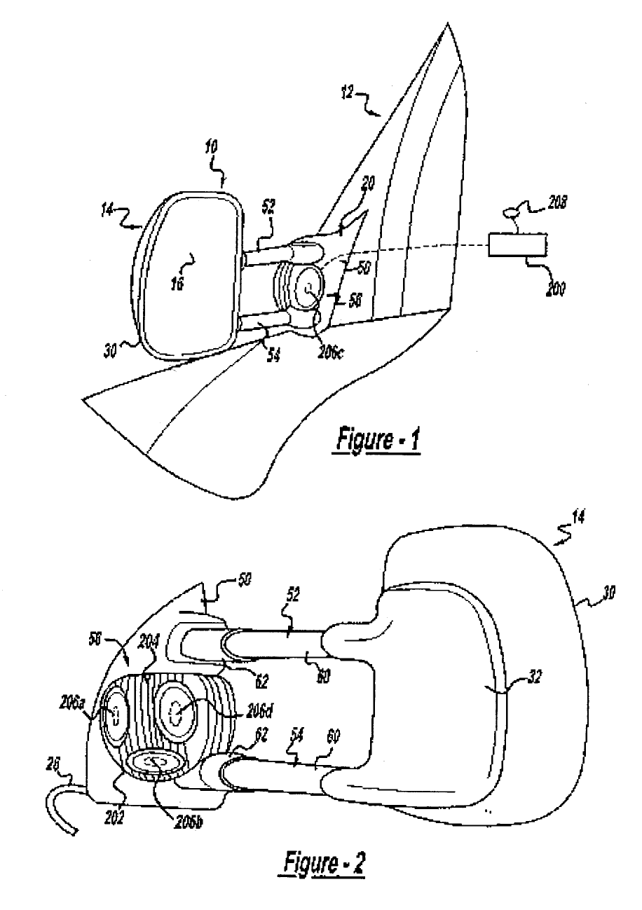

Referring to the Figures, wherein like numerals indicate like or corresponding parts throughout the several views, an exterior rearview mirror assembly for use with an automotive vehicle is generally shown at 10 in FIGS. 1 and 2. Referring specifically to FIG. 1, the mirror assembly 10 includes a support base 12 having a first end 14 and an opposite distal second end 16. The first end 14 is adapted to be fixedly secured to the side of a vehicle, such as an exterior A-pillar or door panel as depicted at 18. The support base 12 extends outwardly from the door panel 18 along a generally horizontal plane from the first end 14 to the second end 16. The mirror assembly 10 further includes a mirror housing 20 operatively coupled to the support base 12. More specifically, the mirror housing 20 includes a hollow shell portion 22 having a front opening 24 and an extension arm portion 26 extending from the shell portion 22 and coupled to the support base 12. The arm portion 26 is coupled to the support base 12 by a power and/or manual pivot mechanism 28, as is conventionally known in the art and to one skilled in the art. The pivot mechanism 28 pivots the mirror housing 20 about the support base 12 between an extended use position, as shown in FIG. 1, and a folded, or stowed, position as shown in FIG. 2.

The mirror assembly 10 also includes a mirror pane 30 operatively coupled to the mirror housing 20 by a swivel member 32. The mirror pane 30 is a reflex glass pane for providing a reflective view to the occupant of the vehicle. The swivel member 32 pivotally connects the mirror pane 30 to the mirror housing 20 for providing articulating, or pivotal, movement of the mirror pane 30 with respect to the mirror housing 20 in order to adjust the angular view through the mirror pane 30 from the vehicle as is commonly known to one skilled in the art. The mirror assembly 10 additionally includes at least one light source 34 mounted to the support base 12 for illuminating at least one source of light from the mirror assembly 10. It should be appreciated that the light source 34 may also be mounted to the mirror housing 20 without varying from the scope of the invention.

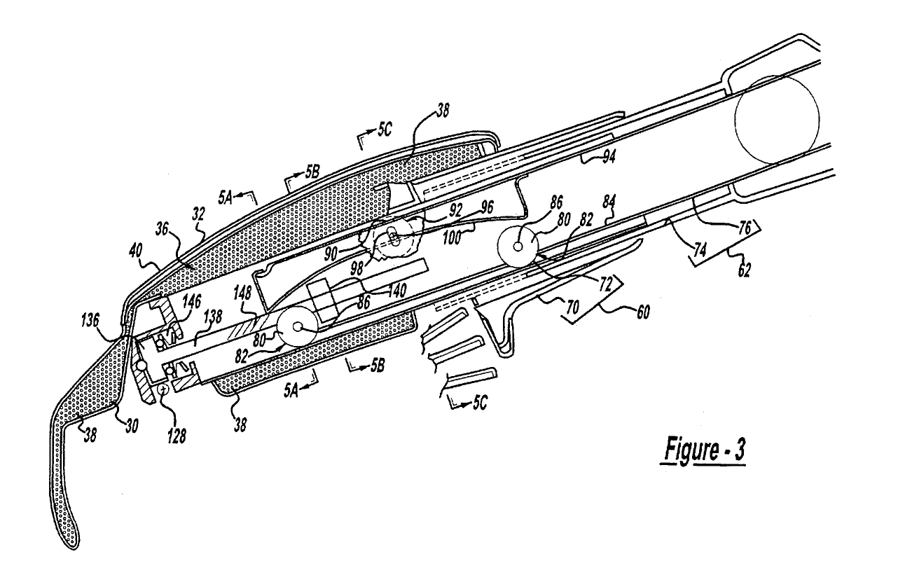

Referring to FIG. 3, the distal second end 16 of the support base 12 and the light source 34 is shown. The second end 16 of the support base 12 includes an inner wall 36, a rear wall 38 projecting outwardly from the inner wall 36, and an upper wall 40 interconnecting the inner wall 36 and the rear wall 38. The inner wall 36, rear wall 38, and upper wall 40 form a partial funnel-like structure on the second end of the support base 12. A hollow and transparent lens 42 is removably secured to the second end 16 of the support base 12 and covers the inner wall 36, rear wall 38 and upper wall 40. The lens 42 may be clear plastic, colored or include fresnel lenses imbedded therein for shaping light from the light source 34. The light source 34 further includes a plurality of light filaments 44, 46, 48. A first light filament 44 is fixedly secured to the inner wall 36, a second light filament 46 is secured to the rear wall 38 and a third light filament 48 is secured to the upper wall 40. The light filament may be an LED, as shown in FIG. 3, or may include a bulb filament, or other known light-producing source. The light filaments 44, 46, 48 project an array of light in a discrete direction from the end of the support base 12. More specifically, the light filament 44 projects an array of light outwardly from the mirror assembly 10 and generally perpendicular from the side of the vehicle. The light filament 46 projects an array of light rearward toward the back or rear of the vehicle. Finally, the light filament 48 projects an array of light downwardly toward the ground adjacent the side of the vehicle.

Referring again to FIG. 1, the mirror assembly 10 further includes an actuator 50 operatively connected to the light source 34 for actuating and illuminating the light source 34 to project the array of light in one of a plurality of discrete directions. More specifically, the actuator 50 is electrically connected to each of the light filaments 44, 46, 48 for actuating and illuminating each of the light filaments 44, 46, 48. When activated, the light filament 44, 46, or 48 projects an array of light in the respective discrete direction as described above. The actuator 50 of the preferred embodiment is a series of electrical circuits connected to each of the light filaments 44, 46, 48 for sending an electrical current to the light filament 44, 46, or 48 to actuate and illuminate the filament 44, 46, 48.

The mirror assembly 10 also includes a controller, shown schematically at 52 in FIG. 1, for controlling the actuator 50 and illuminating the light source 34 to project the array of light in a selective one of the plurality of discrete directions. That is, the controller 52 sends a signal to the actuator 50 to selectively actuate one of the light filaments 44, 46, or 48 to project the array of light in the respective discrete direction from the light filament 44, 46, or 48. The controller 52 receives input signals 54 from various components 56 of the vehicle and transmits an output signal 58 to the actuator 50 to selectively actuate and illuminate one of the light filaments 44, 46, or 48. More specifically, the components 56 of the vehicle transmitting input signals 54 to the controller 52 may include one or more of the following: a vehicle “key fob” for locking and unlocking the doors of the vehicle, a sensor for indicating the open and closed state of the vehicle doors, a vehicle transmission, a vehicle transmission selector, and/or an ignition sensor.

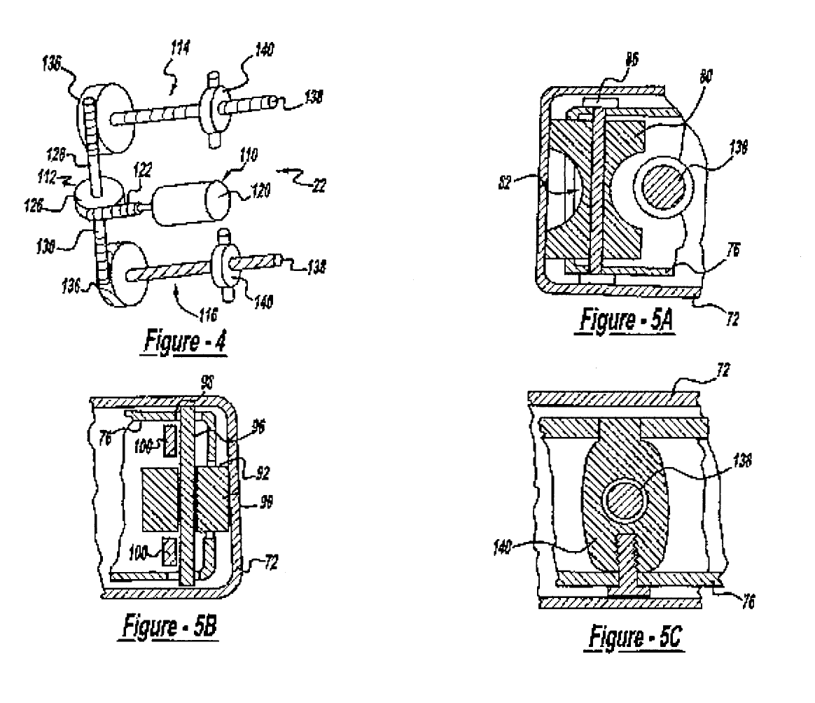

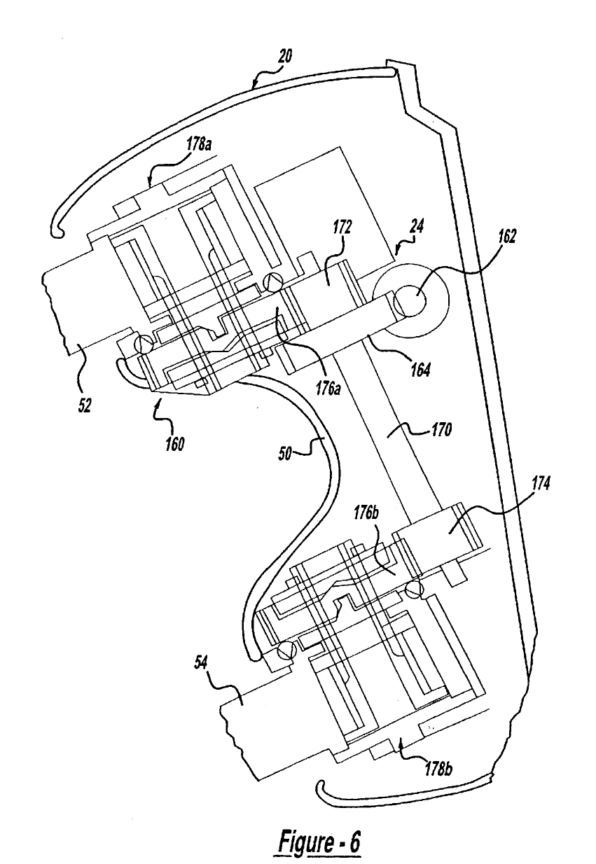

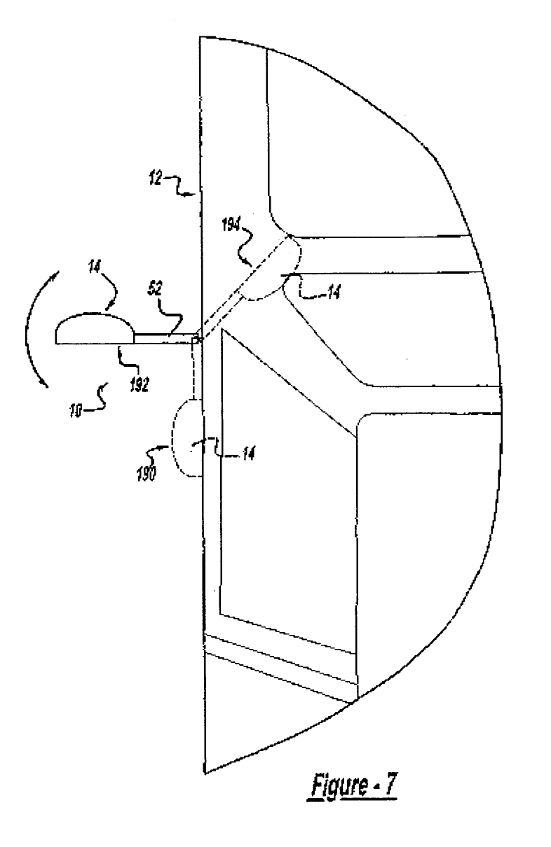

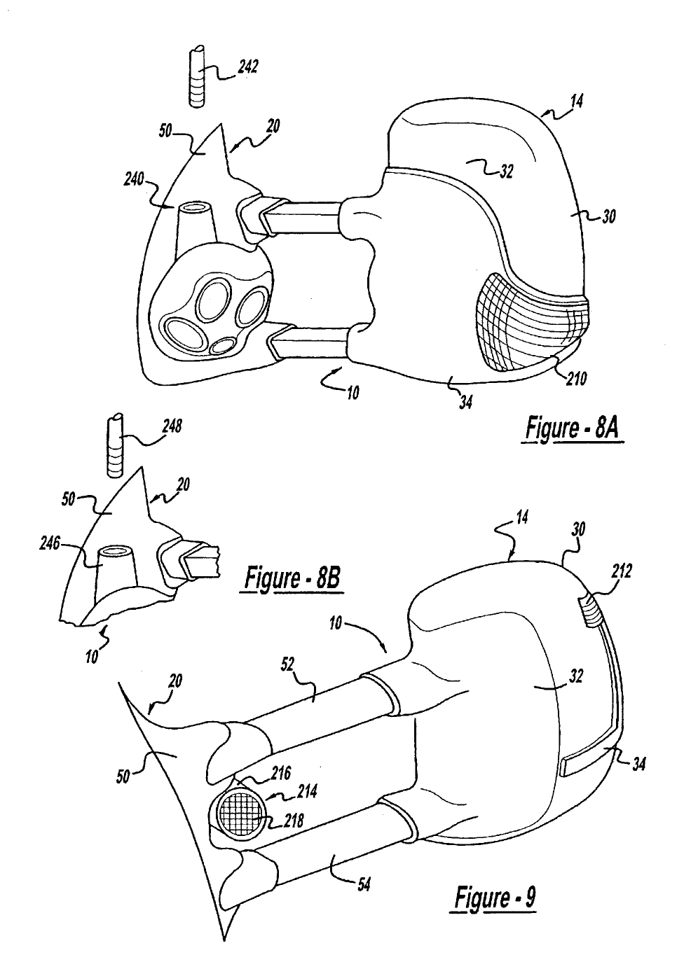

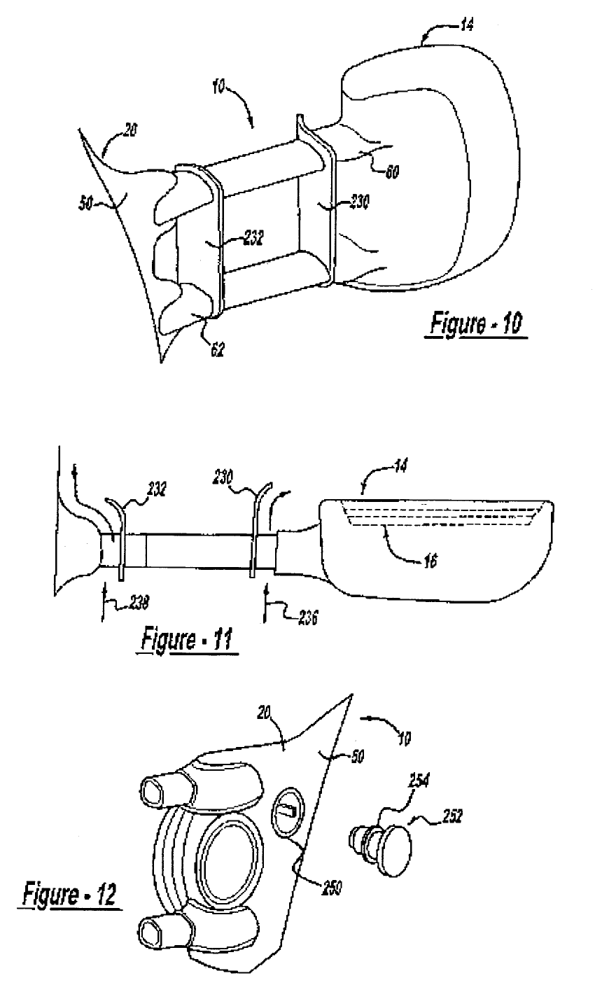

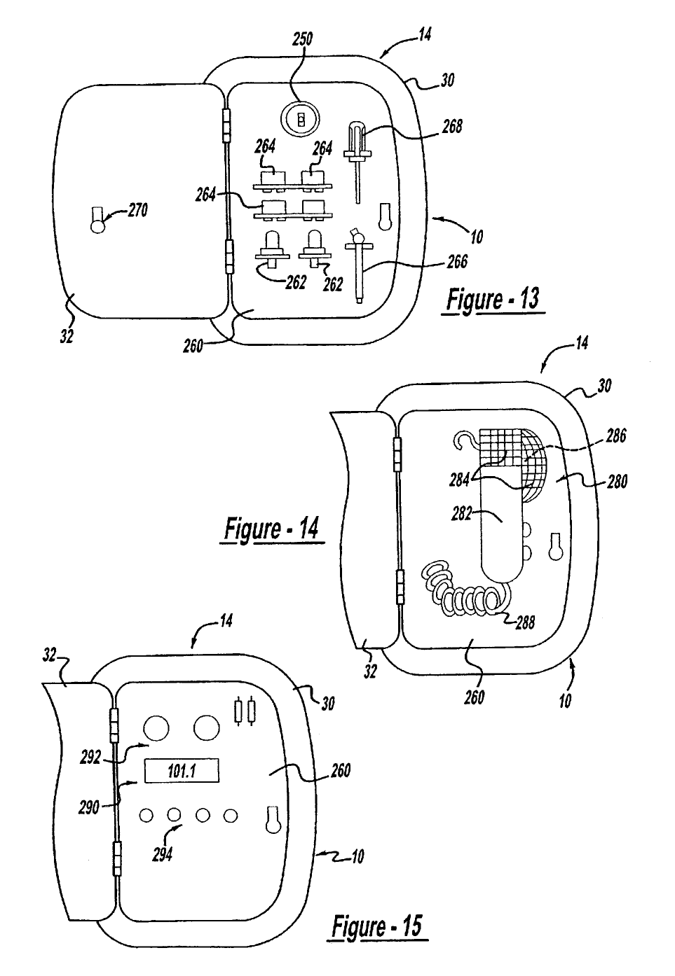

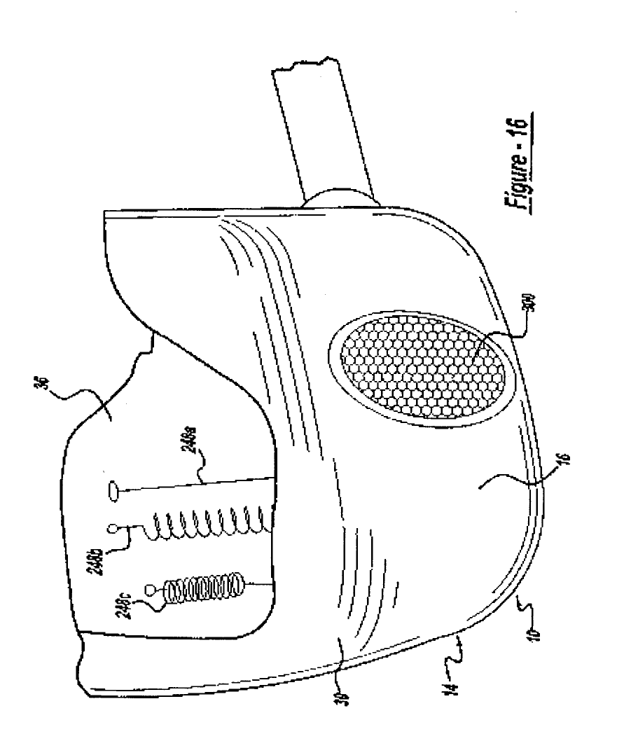

Referring to FIG. 4, a control table 60 is shown illustrating the operation of the mirror assembly 19. In operation when the vehicle operator is approaching the vehicle, the mirror housing 20 is in the folded position and the mirror pane 30 remains parked in its previously operator adjusted position, or “normal” position. If the operator activates the keyfob component 56 to unlock the doors of the vehicle, the controller 52 sends a signal to the actuator 50 and activates the light source 34, or assist light, to an “ON” condition. More specifically, the light filament 44 is turned on and illuminated to direct light from the mirror assembly 10 to assist the operator in locating the vehicle. It should be appreciated that the controller 52 and actuator 50 may activate each of the light filaments 44, 46, and 48 to project additional light from the mirror assembly 10 if desired. After the keyfob component 56 is activated and the operator continues to approach the vehicle, the controller 52 sends a signal to the actuator 50 to switch the light source 34 from illuminating filament 44 to filament 48 to project light downwardly from the mirror assembly 10 toward the ground adjacent the side door of the vehicle to assist in ingress and egress to the vehicle. The light filament 48 is activated after a predetermined period of time, delta T, has elapsed, such as one or two minutes. Once the operator opens the door of the vehicle, the assist light 34 is turn “OFF”. Next, when the ignition component 56 is activated to the “ON” condition to start the vehicle, the pivot mechanism 28 may automatically pivot the mirror housing 20 from the folded position to the extended use position. When the transmission component 56 is selected to a “DRIVE” position, the mirror housing 20 remains in the extended position and the light source 34 remains “OFF”. If the operator places the vehicle transmission in the “REVERSE” selection, the mirror pane 30 may be powered to the downward viewing position and the controller 52 sends a signal to the actuator 50 to illuminated the light filament 46 to the “ON” position to assist the vehicle operator in viewing to the rear of the vehicle.

Finally, when the ignition component 56 of the vehicle is turned “OFF” and/or the keyfob component 56 is activated to “LOCK” the vehicle, the pivot mechanism 28 pivots the mirror housing 20 to the folded position and the light source 34 is turned “OFF”. It should be appreciated that the controller 52 may be program to control and actuate the pivot mechanism 28 for folding of the mirror housing 20, the articulation of the mirror pane 30 and the activation of the light source(s) 34, either independently, combined or as desired for various combinations.

The invention has been described in an illustrative manner, and it is to be understood that the terminology, which has been used, is intended to be in the nature of words of description rather than of limitation.

Many modification and variations of the present invention are possible in light of the above teachings. It is, therefore, to be understood that within the scope of the appended claims, the invention may be practiced other than as specifically described.

What is claimed is:

1. An exterior rearview mirror assembly for use on an automotive vehicle comprising:
a support base having a first end adapted to mount said mirror assembly to the vehicle and an opposite second end;
a mirror housing coupled to said support base;
a reflective mirror pane supported by said mirror housing for providing a reflected view from the vehicle;
at least one light source mounted to one of said support base and said mirror housing for illuminating at least one array of light;
an actuator operatively connected to said light source for actuating and illuminating said light source to project said array of light in one of a plurality of discrete directions; and
a controller for controlling said actuator and illuminating said light source to project said array of light in a selective one of said plurality of discrete directions.

2. A mirror assembly as set forth in claim 1 wherein said light source includes at least three light filaments mounted to one of said support base and said mirror housing for illuminating in three corresponding arrays of light in different discrete directions.

3. A mirror assembly as set forth in claim 2 further including a pivot mechanism for pivotally coupling said mirror housing to said support base for providing pivotal movement of said mirror housing between an extended use position extending generally transverse and perpendicular from the vehicle and a folded position pivoted adjacent the side of the vehicle.

4. A mirror assembly as set forth in claim 3 wherein said second end of said support base includes an planar inner wall, a planar rear wall generally perpendicular to said inner wall, and a planar upper wall generally perpendicular to each of said inner and rear walls.

5. A mirror assembly as set forth in claim 4 wherein one of said light filaments is fixedly secured to each of said inner wall, rear wall and upper wall for illuminating said array of light in said discrete direction defined as generally perpendicular to said plane of said respective inner rear and upper wall.

6. A mirror assembly as set forth in claim 5 further including a generally transparent lens removably coupled to said second end of said support base for enclosing said light filaments while allowing said array of light to project therethrough.

7. A mirror assembly as set forth in claim 6 wherein said mirror housing includes a generally hollow shell portion having a front opening and an extension arm portion extending from said shell portion and pivotally coupled to said first end of said support base by said pivot mechanism.

8. A mirror assembly as set forth in claim 7 further including a mirror pane operatively coupled to said shell portion by a swivel member and seated in said opening for pivotal movement to provide a selective rearward reflective view from said mirror assembly.

9. A mirror assembly as set forth in claim 8 wherein said actuator is electrically connected to each of said light filaments for independent actuating each of said light filaments to project said arrays of light.

10. A mirror assembly as set forth in claim 9 wherein said controller is electrically connected to said actuator for providing an output signal to said actuator selectively illuminating one or more of said light filaments in response to said controller receiving an input signal from a light selection component.

11. A mirror assembly as set forth in claim 10 wherein said light filaments include an LED.

12. A mirror assembly as set forth in claim 10 wherein said light filaments include a bulb filament.
